(19) United States
(12) Patent Application Publication
(10) Pub. No.: US 2019/0014943 A1
(43) Pub. Date: Jan. 17, 2019

(54) MULTICOOKER

(71) Applicant: SharkNinja Operating LLC, Needham, MA (US)

(72) Inventors: Aaron Michael Gill, Brookline, MA (US); Michael Paul Phillips, Swampscott, MA (US); Samuel Andrew Seton Ferguson, Medford, MA (US); Amy Lorraine Golino, Lovell, ME (US); Mackenzie Lee Swanhart, Boston, MA (US)

(21) Appl. No.: 16/034,477

(22) Filed: Jul. 13, 2018

Related U.S. Application Data
(60) Provisional application No. 62/532,687, filed on Jul. 14, 2017.

(51) Int. Cl. A47J 36/32; A47J 27/00; A47J 36/22; A23L 5/10

(52) U.S. Cl. CPC A47J 36/32; A47J 27/004; A23V 2002/00; A23L 5/15; A47J 36/22

(57) ABSTRACT

A cooking system includes a housing and at least one heating element connected to the housing. A control panel is operable to control operation of the at least one heating element. The control panel includes at least one input operable to select a stored sequence of operation of said at least one heating element from a plurality of stored sequences of operation.

### CROSS-REFERENCE TO RELATED APPLICATIONS

This application claims the benefit of U.S. Provisional No. 62/532,687 filed Jul. 14, 2017, which is incorporated herein by reference in its entirety.

### BACKGROUND

Exemplary embodiments of the present disclosure relate to cooking devices such as crock pots and pressure cookers. More specifically, the present disclosure relates to a multicooker device configured to perform the operation of several distinct cooking devices.

Cooking devices, such as crock pots having side or bottom heating elements are known. Switching operation between the heating elements and/or running them simultaneously to achieve different cooking modes can be confusing to the user. Therefore a cooking system operable to automatically transition operation of the heating elements would be beneficial to a user.

### SUMMARY

According to one embodiment, a cooking system includes a housing and at least one heating element connected to the housing. A control panel is operable to control operation of the at least one heating element. The control panel includes at least one input operable to select a stored sequence of operation of said at least one heating element from a plurality of stored sequences of operation.

In addition to one or more of the features described above, or as an alternative, in further embodiments each of said plurality of stored sequences selectable via said at least one input corresponds to a recipe identified by a distinct alphanumeric indicator.

In addition to one or more of the features described above, or as an alternative, in further embodiments said control panel further comprises a display associated with said at least one input, said display being operable to show said alphanumeric indicator of said selected stored sequence of operation.

In addition to one or more of the features described above, or as an alternative, in further embodiments each of said recipes corresponding to said plurality of stored sequences of operation of said at least one heating element is operable to cook a meal in less than or equal to 30 minutes.

In addition to one or more of the features described above, or as an alternative, in further embodiments each of said recipes corresponding to said plurality of stored sequences of operation of said at least one heating element is operable to cook a grain.

In addition to one or more of the features described above, or as an alternative, in further embodiments each of said recipes corresponding to said plurality of stored sequences of operation of said at least one heating element is operable to poach a food product.

In addition to one or more of the features described above, or as an alternative, in further embodiments each of said recipes corresponding to said plurality of stored sequences of operation of said at least one heating element is operable to form a food product having layers of flavors.

In addition to one or more of the features described above, or as an alternative, in further embodiments each of said stored sequences of operation of said at least one heating mechanism includes at least one sequence blocks.

In addition to one or more of the features described above, or as an alternative, in further embodiments said at least one sequence block includes operating said at least one heating element to achieve a desired temperature for a defined amount of time.

In addition to one or more of the features described above, or as an alternative, in further embodiments said at least one sequence block includes operating said at least one heating element to achieve another desired temperature for another defined amount of time, the desired temperature and the another desired temperature being different.

In addition to one or more of the features described above, or as an alternative, in further embodiments said at least one sequence block includes deenergizing said at least one heating mechanism to allow liquid within the cooking system to simmer.

In addition to one or more of the features described above, or as an alternative, in further embodiments said at least one sequence block includes regulating a temperature generated by said at least one heating element for a defined amount of time.

In addition to one or more of the features described above, or as an alternative, in further embodiments regulating said temperature includes operating said at least one heating mechanism to control the temperature within a predefined threshold.

In addition to one or more of the features described above, or as an alternative, in further embodiments regulating said temperature includes sensing a temperature of the cooking system and comparing a sensed temperature to a desired temperature to determine whether said sensed temperature is within said predefined threshold.

According to another embodiment, a method of operating a cooking system includes selecting a mode of operation of the cooking system via an input, energizing at least one heating mechanism of the cooking system in response to selecting said mode of operation, and regulating a temperature generated by said at least one heating mechanism within a predefined threshold.

In addition to one or more of the features described above, or as an alternative, in further embodiments regulating said temperature includes sensing said temperature generated by said at least one heating mechanism.

In addition to one or more of the features described above, or as an alternative, in further embodiments regulating said temperature includes selectively energizing and de-energizing said at least one heating mechanism in response to sensing said temperature.

In addition to one or more of the features described above, or as an alternative, in further embodiments said predefined threshold is between about 1° C. and about 3° C.

In addition to one or more of the features described above, or as an alternative, in further embodiments selecting said mode of operation includes selecting a manual mode of operation.

In addition to one or more of the features described above, or as an alternative, in further embodiments selecting said mode of operation includes selecting a mode of operation having a stored sequence of operation associated therewith.

In addition to one or more of the features described above, or as an alternative, in further embodiments regulating said temperature generated by said at least one heating mechanism occurs automatically in response to selecting said mode.

### BRIEF DESCRIPTION OF THE FIGURES

The accompanying drawings incorporated in and forming a part of the specification embodies several aspects of the present disclosure and, together with the description, serves to explain the principles of the disclosure. In the drawings:

FIG. 1 is a front view of a cooking system according to an embodiment;

FIG. 2 is an exploded perspective view of the cooking system of FIG. 1 according to an embodiment;

FIG. 3 is an exploded perspective view of the cooking system of FIG. 1 according to another embodiment;

FIG. 4 is a schematic cross-sectional view of the housing of the cooking system according to an embodiment;

FIG. 5 is a schematic diagram of a control system of the cooking system according to an embodiment;

FIG. 6 is a front view of a controller of the cooking system according to an embodiment;

FIGS. 7A-7E are various schematic diagrams illustrating the block segments of a stored sequence of operation according to an embodiment; and

FIG. 8 is a schematic diagram illustrating a method of regulating a temperature within the container of the cooking system according to an embodiment.

The detailed description explains embodiments of the disclosure, together with advantages and features, by way of example with reference to the drawings.

### DETAILED DESCRIPTION

Referring now to the FIGS., a perspective view of a cooking system 20 configured to perform multiple cooking operations is illustrated. As shown, the cooking system 20 includes a housing 22 and a container 24 receivable within the housing 20. In the illustrated, non-limiting embodiment, one or more handles 26 extend outwardly from the housing 22 to provide a user with a location to more easily grasp the system 20. Although two handles 26 are shown, embodiments having no handles, a single handle, or more than two handles are also within the scope of the disclosure. In addition, a bottom or base 28 of the housing 22 may include a generally planar surface for directly contacting a supporting surface such as a countertop. Alternatively, one or more feet 30 may extend from the base 28 of the housing 22 to define a surface on which the cooking system 20 is configured to contact an adjacent supporting surface.

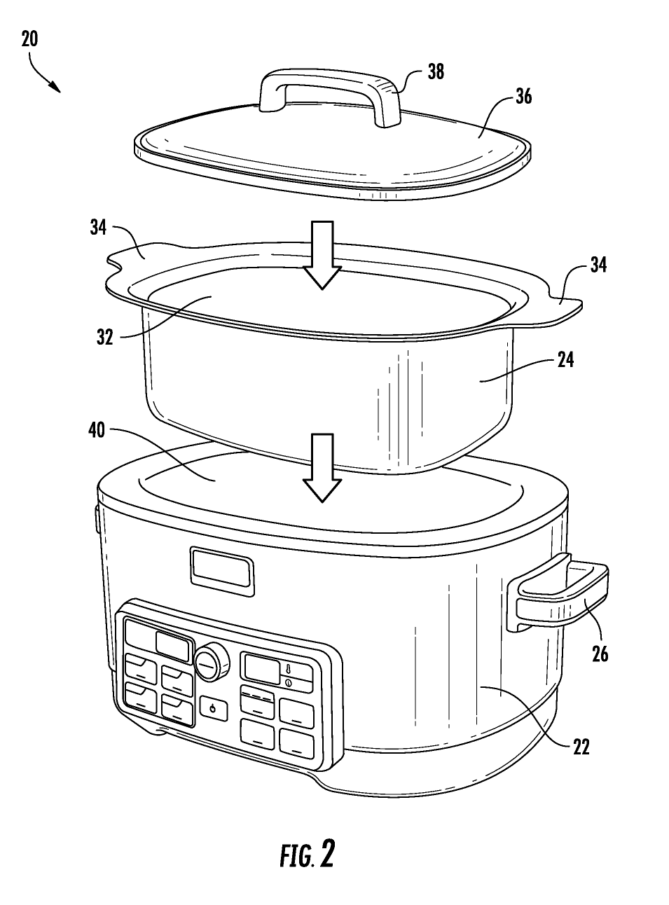

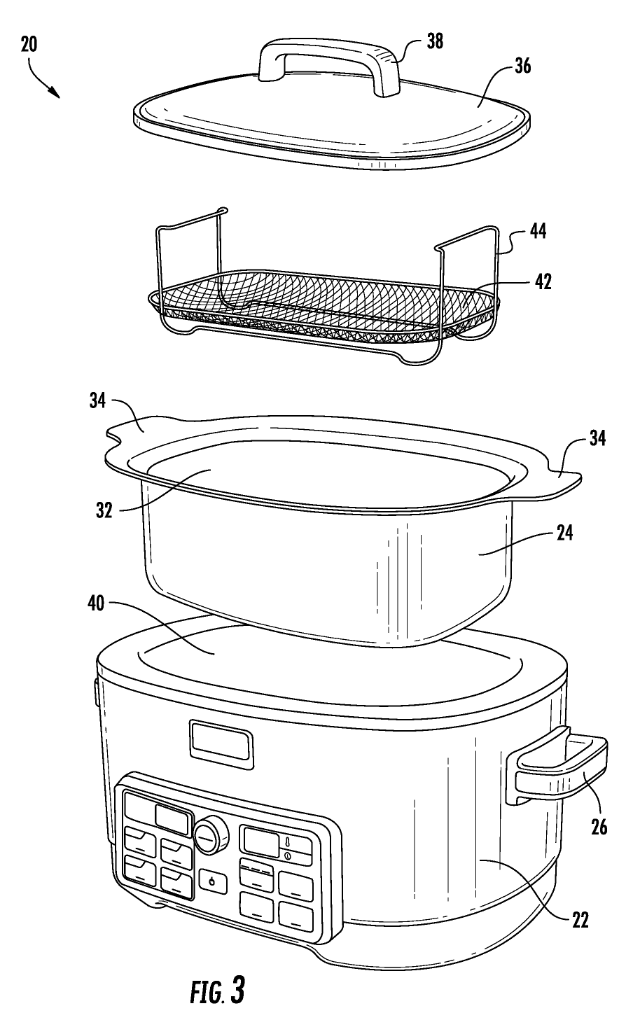

The container 24, best shown in FIGS. 2 and 3, has a generally hollow interior 32 designed to receive and retain one or more consumable products, such as food products for example, therein. Examples of food products suitable for use with the cooking system 20, include but are not limited to, bread, rice, grains, pasta, vegetables, fruits, dairy products, meats, fish, and poultry, among others. The container 24 may be a pot formed from a ceramic, metal, or die cast aluminum material, However, any suitable material capable of withstanding the high temperatures required for cooking food products is contemplated herein. In an embodiment, the container 24 has one or more handles 34 formed therein.

The cooking system 20 may include a lid 36 connectable to a surface of the container 24 and/or housing 22 to seal the hollow interior 32 of the container 24. The lid 36 can be made of any suitable material, such as glass, aluminum, or stainless steel for example. Further, the lid 36 may, but need not, include one or more handles 38 for removably coupling the lid 36 to the remainder of the cooking system 20. In an embodiment, the cooking system 20 includes one or more fasteners (not shown) for securing the lid 36 and/or the container 24 to the housing 22. Any suitable type of fastener capable of withstanding the heat associated with the cooking system 20 is considered within the scope of the disclosure.

FIGS. 2 and 3 are perspective view of the cooking system 20. As shown, the container 24 is generally receivable within a complementary opening 40 formed in the housing 22. In some instances a liner (not shown) may be positioned generally between the housing 22 and the container 24. In such embodiments, the liner may be a separate component removably coupled to the interior of the housing 22. With reference to FIG. 3, in an embodiment, a rack 42 is receivable within the hollow interior 32 of the container 24. The rack 42 has a generally porous structure, such as formed from mesh or wire for example, so that heat and/or steam generated within the hollow interior 32 may flow through the openings in the porous structure to cook one or more food items disposed on the rack 42. When the rack 42 is positioned within the hollow interior 32, the rack 42 does not extend beyond the upper surface of the container 24, and therefore does not interfere with the connection of the lid 36 to the housing 22 and/or container 22. In an embodiment, the rack 42 may include one or more handles 44 to allow a user to more easily grasp and manipulate the rack 42.

With reference to FIG. 4, the cooking system 20 includes a plurality of heating elements configured to communicate with the container 24 during operation of the cooking system 20. As shown, one or more first heating elements 46 may be disposed at the base 28 of the housing 22, adjacent the bottom of the opening 40 formed in the housing 22. At least one second heating element 48 is disposed substantially circumferentially about a sidewall 50 of the housing 22. In the illustrated, non-limiting embodiment, two second heating elements 48 are arranged adjacent opposing sidewalls 50 of the housing 22. Although the heating elements 46, 48 are illustrated and described herein within the housing 22, in embodiments where a liner is disposed between the housing 22 and the container 24 it should be understood that the heating elements 46, 48 may be mounted at similar positioned about the liner.

The first and second heating elements 46, 48 are operable independently or in combination to apply a predetermined power setting to cook the food products within the container 24. In an embodiment, at least one of the first heating element 46 and the second heating element 48 is capable of converting water to steam to facilitate the cooking of food products within the container 24. In operation, the heating elements 46, 48 are capable of cooking the food products independent of the loading of the food products. In other words, the heating elements 46, 48 are capable of cooking the food products independent of the amount of food products within the container 24.

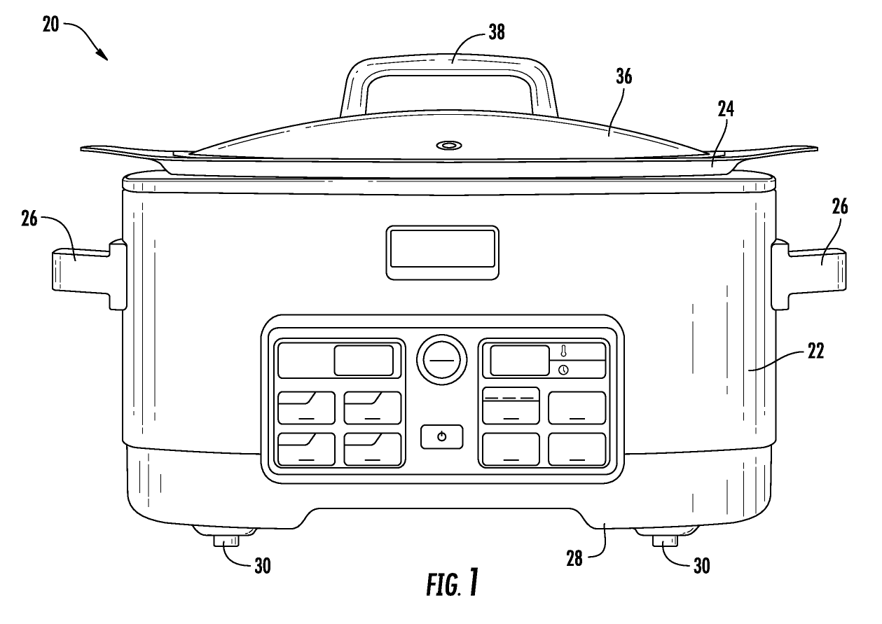

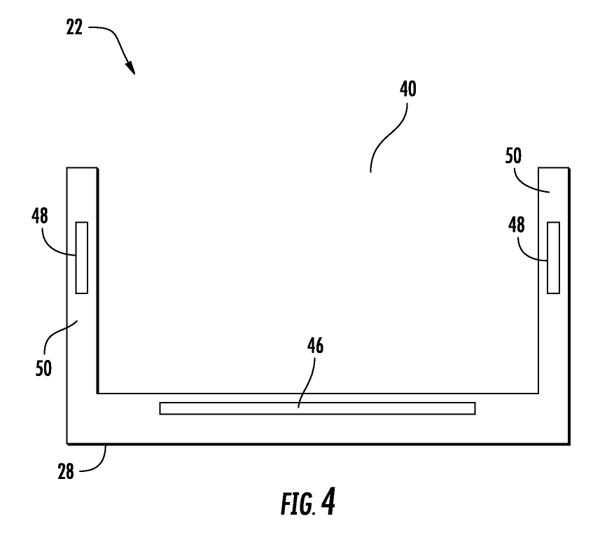

With reference again to FIGS. 1-3, a control panel or user interface 60 of the cooking system 20 is positioned adjacent one or more sides of the housing 22. The control panel 60 includes one or more inputs associated with energizing the one or more heating elements 46, 48 of the cooking system 20 and for selecting various modes of operation of the cooking system 20. One or more of the inputs may include a light or other indicator to show that the respective input has been selected. Operation of the plurality of inputs will be described in more detail below. As shown in FIG. 5, a control system of the cooking system 20 includes a controller or processor 64 for controlling operation of the heating elements 46, 48, and in some embodiments for executing stored sequences of heating operation. The processor 62 is operably coupled to the control panel 60 and to the heating elements 46, 48. In addition, one or more sensors 64 for monitoring a temperature generated by operation of the heating elements 46, 48 within the container 24 may be arranged in communication with the processor 62.

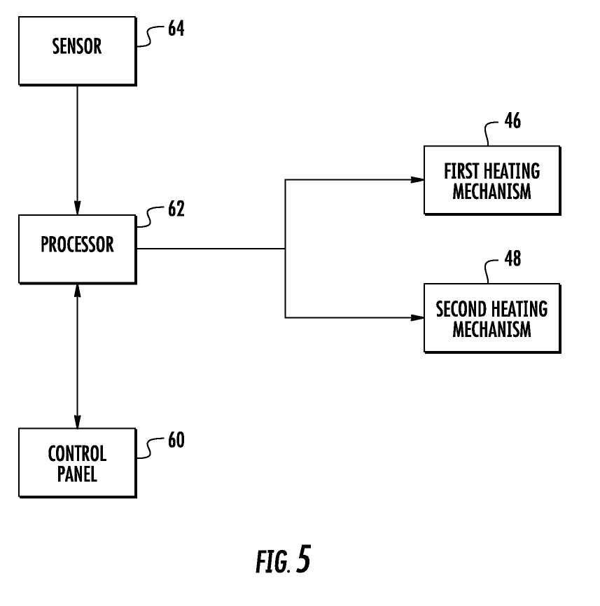

With reference now to FIGS. 6-8, button 70 on the control panel 60 is an on/off button which allows the user to activate or deactivate the control panel 60. When the control panel 60 is deactivated, none of the heating elements 46, 48 are energized.

In the illustrated, non-limiting embodiment, the control panel 60 includes at least one input 72, such as a button for example although any suitable structure may be utilized, operable to select a stored sequence of operation of at least one heating element 46, 48 from a plurality of stored sequences. In some cases, the stored sequences may be particularly well suited for a given method of food preparation and/or for particular ingredients or types of ingredients. The control panel 60 may additionally include a display 74 separate from and associated with the at least one input 72. However, embodiments where the display 74 is integrated into the at least one input 72 are also contemplated herein.

The plurality of stored sequences associated with the at least one input 72 may be stored within a memory accessible by the processor 62. Alternatively, the plurality of stored sequences may be stored remotely from the cooking system 20, and may be accessed by the processor 62, such as via wireless communication for example. Each of the stored sequences of operation associated with the at least one input 72 corresponds to a particular recipe. Each of the plurality of recipes associated with the at least one input 72, including ingredients, parameters, and other directions associated therewith, may be located within a manual, pamphlet, or sheet for reference by the user.

The at least one input 72 may include a button 72a, titled “Quick Meals” in the non-limiting embodiments illustrated in the FIGS., operable to select a stored sequence of operation from a plurality of stored sequences associated with a plurality of recipes suitable to fully cook the food products disposed within the container 24 in a predetermined time period, such as in thirty minutes of less for example. In an embodiment, the at least one input 72 of the control panel 62 includes a button 72b titled “Layered Bowls.” The button 72b is similarly operable to select a stored sequence of operation from a plurality of stored sequences associated with a plurality of recipes suitable to fully cook the food products disposed within the container 24 to create a meal (i.e. including more than one ingredient) that has layers of flavors incorporated therein. The recipes associated with button 72b typically include providing one or more previously cooked ingredients to the container 24 prior to initiating operation of a stored sequence.

Alternatively, or in addition, the at least one input 72 includes a button 72c titled “Grains” operable to select a stored sequence of operation from a plurality of stored sequences associated with a plurality of recipes suitable to fully cook small or large batches of grains. In another embodiment, the at least one input 72 includes a button 72d titled “Poached Infusion” operable to select a stored sequence of operation from a plurality of stored sequences associated with a plurality of recipes suitable for poaching a variety of food items. Although four distinct buttons 72a-72d operable to select a stored sequence are illustrated and described herein, it should be understood that a cooking system 20 having any number of such inputs is contemplated herein.

When the control panel 60 is activated and one of the at least one inputs 72a-72d is pressed, an alphanumeric indicator corresponding to a selected recipe number and a stored sequence associated therewith is shown on the display 74. For example, when any of the inputs 72a-72d is pressed a single time, the display 74 may show a “1” indicating that a first recipe, and therefore a stored sequence of operation associated with the first recipe has been selected. If the button 72a-72d is pressed again, the number “2” may become visible on the display 74, thereby indicating that a second recipe associated with the input 72, and therefore a stored sequence of operation associated with the second recipe has been selected. Accordingly, a user will identify a desired recipe associated with one of the plurality of buttons 72a-72d and will repeatedly press the corresponding button associated until the display 74 indicates that the desired recipe, and therefore stored sequence have been selected.

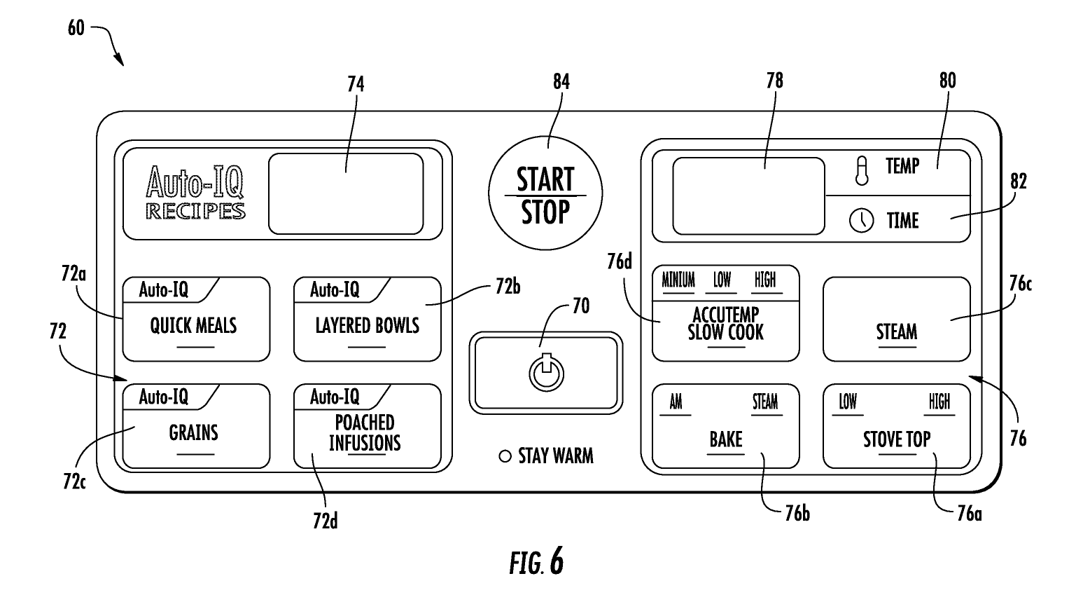

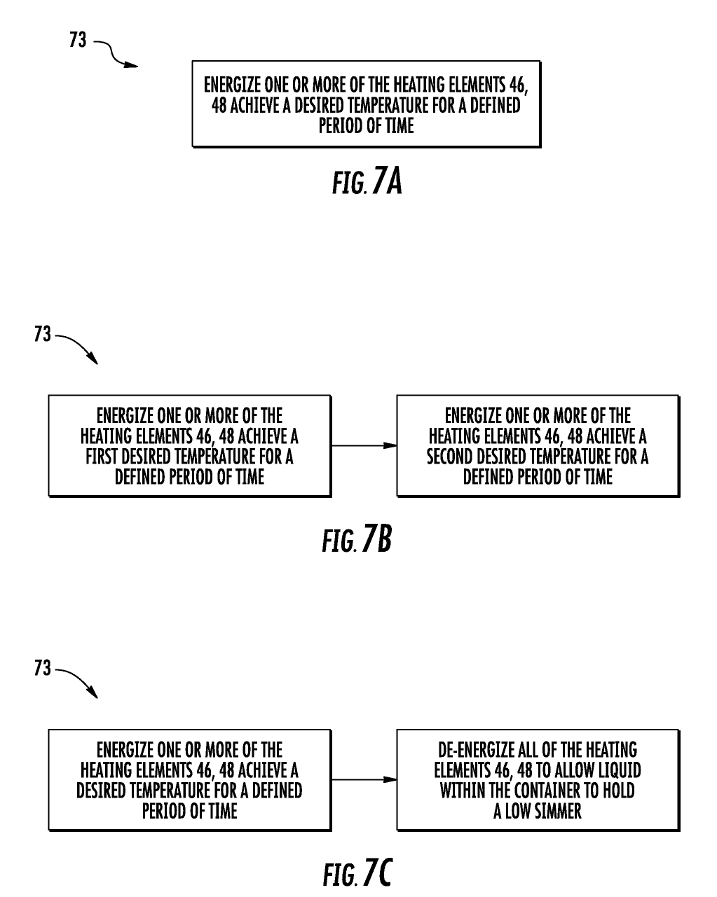

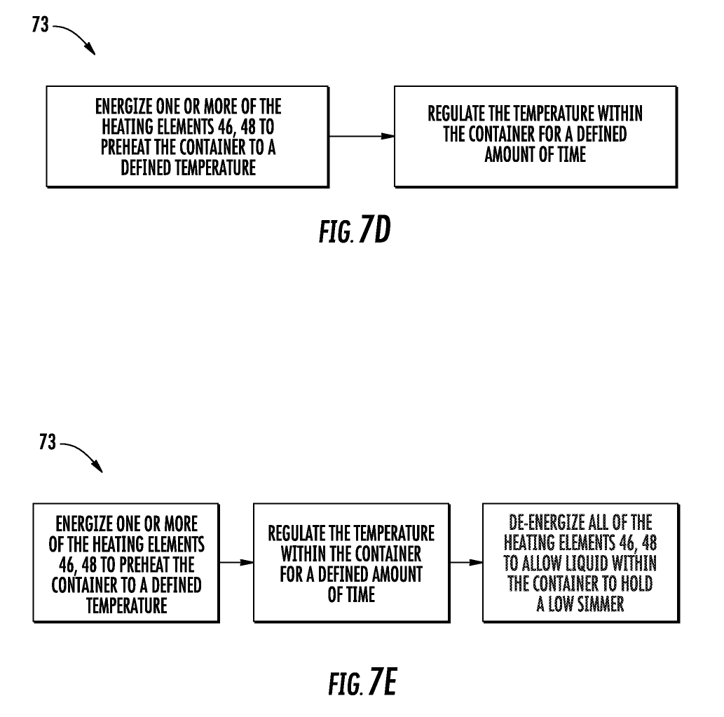

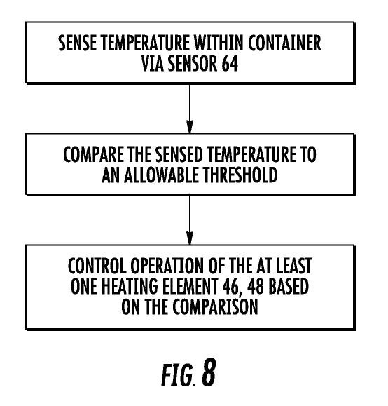

The stored sequences of operation associated with each of the plurality of inputs 72a-72d may vary. Each stored sequence of operation includes one or more sequence blocks or segments. In an embodiment, the stored sequences associated with the “Quick Meals” input 72a and the “Layered Bowl” input 72b may have one of three general constructions depending on the ingredients being used therewith. In a first construction, shown in FIG. 7A, the stored sequence, illustrated schematically at 73, has a single block where one or more of the heating elements 46, 48 are energized to achieve a desired temperature for a defined amount of time. The one or more heating elements 46, 48 that are energized during each stored sequence will depend on the type of food being cooked.

In a second construction, illustrated in FIG. 7B, the stored sequence 73 includes a first block where one or more of the heating elements 46, 48 are energized to achieve a desired first temperature for a defined amount of time and a second block where one or more of the heating elements 46, 48 are energized to achieve a desired second temperature for a defined amount of time. The first temperature and the second temperature are different, and the first and second times may be the same or different. In a third construction, shown in FIG. 7C, the stored sequence 73 includes a first block where one or more of the heating elements 46, 48 are energized to achieve a desired temperature for a defined amount of time and a second block where none of the heating elements 46, 48 are energized to allow liquid within the container 24 to absorb and hold a low simmer.

Similarly, the stored sequences associated with the “Grains” input 72c and the “Poached Infusion” input 72d may have any of a plurality of constructions. In an embodiment, each of the stored sequences, illustrated schematically in FIGS. 7D and 7E, associated with the “Grains” input 72c and the “Poached Infusion” input 72d includes a first block where one or more of the heating elements 46, 48 are energized to preheat the container 24 to a defined temperature and a second block where the temperature of the container 24 is regulated for a given amount of time. The allowable fluctuation in temperature may depend on the type of food being cooked by the cooking system 20. In an embodiment, the allowable fluctuation is between 1° C. and 3° C. In some embodiments, the stored sequences include an additional block where none of the heating elements 46, 48 are energized to allow liquid within the container 24 to absorb and hold a low simmer.

With reference again to FIG. 6, the control panel 60 additionally includes at least one input 76 for manually controlling operation of the cooking system 20. A first input, such as a button 76a, titled “Stove Top” for example, selects operation of the cooking system 20 in a manner similar to a stove to sear, sauté, simmer, and/or brown the ingredients within the container 24. When operated in the stove top mode, the processor 62 may energize both the first and second heating elements 46, 48 to warm the container 24 to a desired temperature. Upon reaching the desired temperature, the processor may de-energize one or more of the heating elements, such as the second heating elements 48 for example. In an embodiment, the cooking system 20 is operable in either a “low” stove top mode or a “high” stove top mode. The temperature maintained within the container 24 during the high mode is greater than the temperature maintained during the low mode. However, the one or more heating elements 46, 48 energized in both the high and low mode may be the same.

Alternatively or in addition, the at least one manual input 76 may include button 76b titled “Bake.” Button 76b selects operation of the cooking device 20 in a manner similar to a conventional oven. In the bake mode, the processor 62 may energize both the first and second heating elements 46, 48 to warm the container 24 to a desired temperature, for example selected by a user. Upon reaching the desired temperature, the processor 62 may then de-energize one or more of the heating elements 46, 48. In an embodiment, the cooking system 20 is operable in either a “dry” bake mode or a “steam” bake mode. A user toggles between the dry and steam modes by repeatedly pressing the button 76b. In general, the dry bake mode is intended for use when no liquid is disposed within the bottom of the container 24, and the steam bake mode is selected when a user places a volume of water, for example water in the container to steam bake the food contained therein. Control of the heating elements 46, 48 may be substantially similar between the dry and steam modes.

The at least one manual input 76 may include a steam button 76c for operating the cooking system 20 in a steam cooking mode. During a steam cooking mode, one or more food products are typically arranged on the rack 42 positioned within the container 24, and therefore offset from the base of the container 24. In addition, an amount of liquid, for example water, is disposed at the bottom of the container 24. Operation of at least one of the heating mechanism 46, 48 causes the water to boil and the steam generated to heat and cook the food products within the container 24. Similar to the stove top and bake modes, the processor 62 may energize both the first and second heating elements 46, 48 to preheat the container 24 to a desired temperature. Upon reaching the desired temperature, the processor 62 may then de-energize one or more of the heating elements, such as the second heating elements 48 for example.

In another embodiment, the at least one manual input 76 includes a button 76d titled “Slow Cook”. When the cooking system 20 is in a slow cook mode of operation, the processor 62 may energize one or both of the first and second heating elements 46, 48 to preheat the container 24 to a desired temperature. Upon reaching the desired temperature, the processor may then de-energize one or more of the heating elements, such as the first heating element 46 for example. Button 74d may be repeatedly pressed to toggle between a “warm”, “low”, and “high” mode of operation. In operation, the temperature within the container 24 is distinct between the warm, low, and high modes. The temperature within the warm mode is generally equal to a food safe temperature configured to prevent the formation of bacteria, but not sufficient to cook the food products contained therein. The temperature of the high mode is greater than the low mode such that food is generally cooked between 30-50% faster in the high mode.

In embodiment, during at least one mode of operation of the cooking system 20, the processor 62 is configured to regulate the temperature within the container 24. In an embodiment, this regulation of the temperature within the container 24 may be applied during operation of the cooking system 20 in the slow cook mode, or in response to selection of the grains input 72c or the poached infusion input 72d. However, it should be understood that such temperature regulation may be used during any of the operational modes of the cooking system 20 disclosed herein.

With reference again to FIG. 5 and to the method of FIG. 8, the cooking system 20 includes at least one sensor 64 for monitoring the operating temperature within the container 24. The sensor 64 may be configured to continuously provide a sensed temperature to the processor 62, or alternatively, may be configured to provide a sensed temperature to the processor 62 at intervals. In response to the feedback provided by the sensor 64, the processor 62 is configured to compare the sensed temperate to an allowable threshold and then in response to that comparison to control operation of the first and second heating elements 46, 48. In an embodiment, the processor 62 is operable to maintain the temperature within a threshold of a desired temperature, such as within 5° C. of the desired temperature, and more specifically between 1-3° C. of the desired temperature for example.

In the event that the sensed temperature exceeds or is trending towards exceeding the threshold, the processor 62 will turn off the at least one heating element 46, 48 being operated until the sensed temperature is within the threshold of the desired temperature. In the event that the temperature is below or is trending towards failing below the threshold, the processor 62 will increase the heat generated by the at least one heating element 46, 48 being operated until the sensed temperature is within the threshold of the desired temperature.

The control panel 60 may include an additional display 78. In an embodiment, display 78 is configured to indicate a temperature and/or a countdown time depending on a mode of operation of the system 20. A temperature button 80 and a time button 82 are associated with the display screen 78. In an embodiment, a rotatable knob 84 may be used in conjunction with the temperature and time buttons 80, 82 to selectively enter a countdown time and/or temperature during one or more modes of manual operation. Although a knob is illustrated and described any suitable input mechanism is contemplated herein.

For example, when in the bake mode, the temperature of the container 24 is controllable, such as in response to pressing the temperature button and via operation of the rotatable knob. The knob 84 may incrementally adjust a temperature of the cooking system 20 with a range of selectable temperatures, such as between 250° F. and 425° F. When one of slow cook, bake, and steam modes have been selected via a manual input 76, a countdown time may be entered by the user in a similar manner (i.e. time button and operation of the knob 84). Further in embodiments where the system 20 is performing a stored sequence in response to selection of one of the inputs 72, the display may indicate initiate a countdown timer on display 78 for the last 5 minutes of the sequence.

In an embodiment, the rotatable knob 84 may be used to scroll through the plurality of selectable stored sequences associated with the at least one input 72, in place of continuously pressing the input. In addition, the cooking system may be operable to automatically start operation of the cooking system after a predetermined time has elapsed once an input has been selected and the necessary information has been provided to the control panel. Alternatively, one or more of the other inputs, such as the knob 84 for example, may be operable, such as by pushing the knob towards the control panel 60, to start and stop operation of the cooking system, regardless of whether the system is following a stored sequence or is in a manual mode.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Exemplary embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A cooking system comprising:
a housing;
at least one heating element connected to said housing; and
a control panel for controlling operation of said at least one heating element, said control panel including at least one input operable to select a stored sequence of operation of said at least one heating element from a plurality of stored sequences of operation.

2. The cooking system of claim 1, wherein each of said plurality of stored sequences selectable via said at least one input corresponds to a recipe identified by a distinct alphanumeric indicator.

3. The cooking system of claim 2, wherein said control panel further comprises a display associated with said at least one input, said display being operable to show said alphanumeric indicator of said selected stored sequence of operation.

4. The cooking system of claim 2, wherein each of said recipes corresponding to said plurality of stored sequences of operation of said at least one heating element is operable to cook a meal in less than or equal to 30 minutes.

5. The cooking system of claim 2, wherein each of said recipes corresponding to said plurality of stored sequences of operation of said at least one heating element is operable to cook a grain.

6. The cooking system of claim 2, wherein each of said recipes corresponding to said plurality of stored sequences of operation of said at least one heating element is operable to poach a food product.

7. The cooking system of claim 2, wherein each of said recipes corresponding to said plurality of stored sequences of operation of said at least one heating element is operable to form a food product having layers of flavors.

8. The cooking system of claim 1, wherein each of said stored sequences of operation of said at least one heating mechanism includes at least one sequence blocks.

9. The cooking system of claim 8, wherein said at least one sequence block includes operating said at least one heating element to achieve a desired temperature for a defined amount of time.

10. The cooking system of claim 9, wherein said at least one sequence block includes operating said at least one heating element to achieve another desired temperature for another defined amount of time, the desired temperature and the another desired temperature being different.

11. The cooking system of claim 9, wherein said at least one sequence block includes deenergizing said at least one heating mechanism to allow liquid within the cooking system to simmer.

12. The cooking system of claim 8, wherein said at least one sequence block includes regulating a temperature generated by said at least one heating element for a defined amount of time.

13. The cooking system of claim 12, wherein regulating said temperature includes operating said at least one heating mechanism to control the temperature within a predefined threshold.

14. The cooking system of claim 13, wherein regulating said temperature includes sensing a temperature of the cooking system and comparing a sensed temperature to a desired temperature to determine whether said sensed temperature is within said predefined threshold.

15. A method of operating a cooking system comprising:
selecting a mode of operation of the cooking system via an input;
energizing at least one heating mechanism of the cooking system in response to selecting said mode of operation; and
regulating a temperature generated by said at least one heating mechanism within a predefined threshold.

16. The method of claim 15, wherein regulating said temperature includes sensing said temperature generated by said at least one heating mechanism.

17. The method of claim 16, wherein regulating said temperature includes selectively energizing and de-energizing said at least one heating mechanism in response to sensing said temperature.

18. The method of claim 15, wherein said predefined threshold is between about 1° C. and about 3° C.

19. The method of claim 14, wherein selecting said mode of operation includes selecting a manual mode of operation.

20. The method of claim 15, wherein selecting said mode of operation includes selecting a mode of operation having a stored sequence of operation associated therewith.

21. The method of claim 15, wherein regulating said temperature generated by said at least one heating mechanism occurs automatically in response to selecting said mode.
